(19) United States
(12) Patent Application Publication
(10) Pub. No.: US 2019/0196964 A1
(43) Pub. Date: Jun. 27, 2019

(54) MEMORY SYSTEM AND OPERATING METHOD THEREOF

(71) Applicant: SK hynix Inc., Gyeonggi-do (KR)

(72) Inventor: Eu-Joon BYUN, Gyeonggi-do (KR)

(21) Appl. No.: 16/037,821

(22) Filed: Jul. 17, 2018

(30) Foreign Application Priority Data
Dec. 21, 2017 (KR) 10-2017-0176873

(51) Int. Cl. G06F 12/02; G06F 12/0811

(52) U.S. Cl. CPC G06F 12/0253; G06F 12/0811; G06F 12/0246

(57) ABSTRACT

A data processing system includes a memory device, a host including a cache memory, first and second buffers, and a controller suitable for controlling the memory device, the host and the first and second buffers performing a first buffering operation of buffering valid data of a victim block of the memory device in the first buffer, a second buffering operation of buffering the valid data buffered in the first buffer in the second buffer, a caching operation of caching the valid data buffered in the second buffer in the cache memory, and a program operation of storing all the valid data of the victim block cached in the cache memory in target blocks of the memory device, wherein the controller performs the first and second buffering operations and the caching operation on the valid data of the victim block in a pipelining scheme.

### CROSS-REFERENCE TO RELATED APPLICATIONS

The present application claims priority under 35 U.S.C. § 119(a) to Korean Patent Application No. 10-2017-0176873, filed on Dec. 21, 2017, the disclosure of which is incorporated herein by reference in its entirety.

### BACKGROUND

### 1. Field

Various embodiments of the present invention generally relate to a memory system. Particularly, the embodiments relate to a data processing system that controls a garbage collection operation, and to an operating method of the data processing system.

### 2. Description of the Related Art

The computer environment paradigm has changed to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts (e.g., a mechanical arm with a read/write head) as compared with a hard disk device. Examples of memory systems having such advantages include universal serial bus (USB) memory devices, memory cards having various interfaces, and solid-state drives (SSD).

### SUMMARY

Various embodiments of the present invention are directed to a data processing system capable of utilizing a memory of a host region to reduce or minimize complexity and performance degradation of a memory system. Various embodiments of the present invention are directed to a data processing system capable of enhancing performance (e.g., speed, stability, etc.) of a garbage collection operation through a cache read. Various embodiments of the present invention are directed to an operating method of the data processing system.

In accordance with an embodiment of the present invention, a data processing system includes: a memory device; a host including a cache memory; first and second buffers; and a controller suitable for controlling the memory device, the host and the first and second buffers to perform a first buffering operation of buffering valid data of a victim block included in the memory device in the first buffer, a second buffering operation of buffering the valid data buffered in the first buffer in the second buffer, a caching operation of caching the valid data buffered in the second buffer in the cache memory, and a program operation of storing all the valid data of the victim block cached in the cache memory in target blocks included in the memory device, wherein the controller performs the first and second buffering operations and the caching operation on the valid data of the victim block in a pipelining scheme between the host and the first and second buffers.

In accordance with an embodiment of the present invention, an operating method of a data processing system includes: buffering valid data of a victim block included in a memory device in a first buffer; buffering the valid data buffered in the first buffer in a second buffer; caching the valid data buffered in the second buffer in a cache memory; and programming all the valid data of the victim block cached in the cache memory into target blocks included in the memory device, wherein the buffering of the valid data of the victim block in the first buffer, the buffering of the valid data of the first buffer in the second buffer and the caching of the valid data of the second buffer in the cache memory are carried out in a pipelining scheme for the valid data of the victim block.

In accordance with an embodiment of the present invention, a memory system includes a memory device including a plurality of blocks, each including a plurality of pages; and a controller suitable for reading a data stored in the memory device in response to a request from a host to transmit the data into the host, and determining whether data stored in all valid page of a specific block are transmitted into the host, wherein the specific block is determined as an erase-target block when the data stored in all valid page of a specific block are transmitted into the host.

These and other features and advantages of the present invention will become apparent to those with ordinary skill in the art to which the present invention belongs from the following description in conjunction with the accompanying drawings.

### BRIEF DESCRIPTION OF THE DRAWINGS

FIG. 1 is a simplified block diagram illustrating a data processing system including a memory system, in accordance with an embodiment of the invention.

FIG. 2 is a simplified schematic diagram illustrating an exemplary configuration of a memory device employed in the memory system shown in FIG. 1.

FIG. 3 is a circuit diagram illustrating an exemplary configuration of a memory cell array of a memory block in the memory device shown in FIG. 1.

FIG. 4 is a simplified block diagram illustrating an exemplary configuration of a memory device and a controller employed in a data processing system, in accordance with an embodiment of the invention.

FIG. 5 is a flowchart illustrating a garbage collection operation, in accordance with an embodiment of the invention.

FIGS. 6 to 14 are diagrams schematically illustrating application examples of the data processing system, in accordance with various embodiments of the invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the invention to those skilled in the art to which this invention pertains. Throughout the disclosure, like reference numerals refer to like parts throughout the various figures and embodiments of the invention. It is noted that reference to “an embodiment” does not necessarily mean only one embodiment, and different references to “an embodiment” are not necessarily to the same embodiment(s).

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the invention.

The drawings are not necessarily to scale and, in some instances, various proportions of the drawings may have been exaggerated for more clearly illustrating certain features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for describing particular embodiments only and is not intended to be limiting of the invention.

As used herein, singular forms are intended to include the plural forms and vice versa, unless the context clearly indicates otherwise.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the disclosure. It will be further understood that terms, such as those defined in commonly used dictionaries, should be interpreted as having a meaning that is consistent with their meaning in the context of the disclosure and the relevant art and will not be interpreted in an idealized or overly formal sense unless expressly so defined herein.

In the following description, numerous specific details are set forth in order to provide a thorough understanding of the invention. The present invention may be practiced without some or all these specific details. In other instances, well-known process structures and/or processes have not been described in detail in order not to unnecessarily obscure the invention.

It is also noted, that in some instances, as would be apparent to those skilled in the relevant art, a feature or element described in connection with one embodiment may be used singly or in combination with other features or elements of another embodiment, unless otherwise specifically indicated.

Hereinafter, the various embodiments of the present invention will be described in detail with reference to the attached drawings.

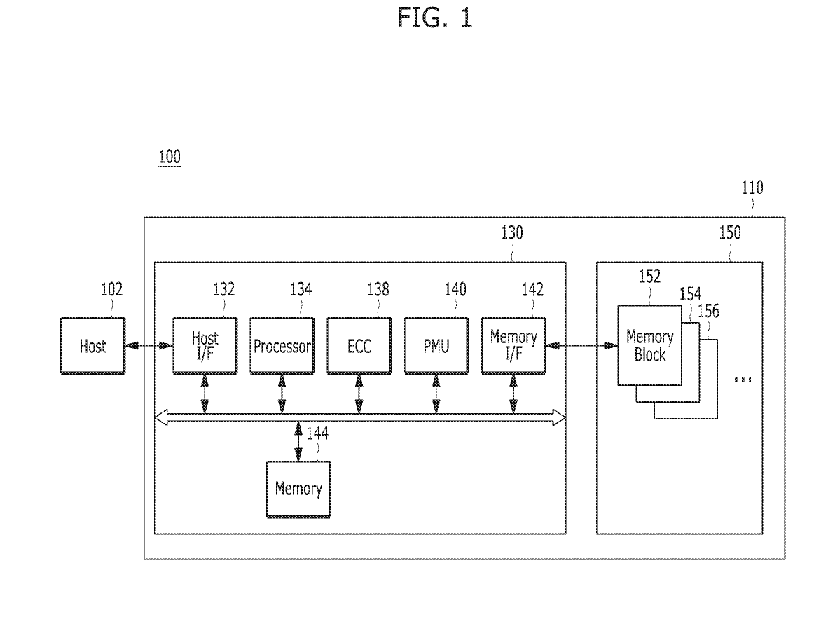

FIG. 1 is a simplified block diagram illustrating a data processing system 100 including a memory system 110 in accordance with an embodiment of the invention.

Referring to FIG. 1, the data processing system 100 may include a host 102 operatively coupled to the memory system 110.

By way of example but not limitation, the host 102 may include portable electronic devices such as a mobile phone, MP3 player and laptop computer or non-portable electronic devices such as a desktop computer, a game machine, a TV and a projector.

The host 102 may include at least one OS (operating system). The OS may manage and control overall functions and operations of the host 102. The OS may support an operation between the host 102 and a user, which may be achieved or implemented by the data processing system 100 or the memory system 110. The OS may support functions and operations requested by a user. By way of example but not limitation, the OS may be divided into a general OS and a mobile OS, depending on whether it is customized for the mobility of the host 102. The general OS may be divided into a personal OS and an enterprise OS, depending on the environment of a user. For example, the personal OS configured to support a function of providing a service to general users may include Windows and Chrome, and the enterprise OS configured to secure and support high performance may include Windows server, Linux and Unix. Furthermore, the mobile OS configured to support a customized function of providing a mobile service to users and a power saving function of a system may include Android, iOS and Windows Mobile. The host 102 may include a plurality of Oss. The host 102 may execute an OS to perform an operation corresponding to a user's request on the memory system 110. Here, the host 102 may provide a plurality of commands corresponding to a user's request to the memory system 110. The memory system 110 may perform certain operations corresponding to the plurality of commands, that is, corresponding to the user's request.

The memory system 110 may store data for the host 102 in response to a request of the host 102. Non-limited examples of the memory system 110 may include a solid-state drive (SSD), a multi-media card (MMC), a secure digital (SD) card, a universal storage bus (USB) device, a universal flash storage (UFS) device, a compact flash (CF) card, a smart media card (SMC), a personal computer memory card international association (PCMCIA) card and a memory stick. The MMC may include an embedded MMC (eMMC), a reduced size MMC (RS-MMC) and micro-MMC. The SD card may include a mini-SD card and micro-SD card.

The memory system 110 may include various types of storage devices. Non-limited examples of storage devices included in the memory system 110 may include volatile memory devices such as a DRAM dynamic random-access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM), and a flash memory.

The memory system 110 may include a memory device 150 and a controller 130. The memory device 150 may store data for the host 102. The controller 130 may control data storage into the memory device 150.

The controller 130 and the memory device 150 may be integrated into a single semiconductor device, which may be included in the various types of memory systems as described above. By way of example but not limitation, the controller 130 and the memory device 150 may be integrated as a single semiconductor device to constitute an SSD. When the memory system 110 is used as an SSD, the operating speed of the host 102 connected to the memory system 110 can be improved. In another example, the controller 130 and the memory device 150 may be integrated as a single semiconductor device to constitute a memory card. By way of example but not limitation, the controller 130 and the memory device 150 may constitute a memory card such as a PCMCIA (personal computer memory card international association) card, a CF card, a SMC (smart media card), a memory stick, an MMC including an RS-MMC and a micro-MMC, a SD card including a mini-SD, a micro-SD and a SDHC, an UFS device, and the like.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device which may retain stored data even though power is not supplied. The memory device 150 may store data provided from the host 102 through a write operation, while outputting data stored therein to the host 102 through a read operation. In an embodiment, the memory device 150 may include a plurality of memory dies (not shown), each memory may include a plurality of planes (not shown), each plane may include a plurality of memory blocks 152 to 156, each of the memory blocks 152 to 156 may include a plurality of pages, and each of the pages may include a plurality of memory cells coupled to a word line. In an embodiment, the memory device 150 may be a flash memory having a 3-dimensional (3D) stack structure.

The controller 130 may control the memory device 150 in response to a request from the host 102. By way of example but not limitation, the controller 130 may provide data read from the memory device 150 to the host 102, and store data provided from the host 102 into the memory device 150. For these operations, the controller 130 may control read, write, program and erase operations of the memory device 150.

More specifically, the controller 130 may include a host interface (I/F) 132, a processor 134, an error correction code (ECC) component 138, a Power Management Unit (PMU) 140, a memory interface 142, and a memory 144 all operatively coupled via an internal bus.

The host interface 132 may process a command and data of the host 102. The host interface 132 may communicate with the host 102 under one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE). The host interface unit 132 may be controlled by, or implemented in, a firmware such as a host interface layer (HIL) for exchanging data with the host 102.

Further, the ECC component 138 may correct error bits of data to be processed by the memory device 150 and may include an ECC encoder and an ECC decoder. The ECC encoder may perform an error correction encoding onto data, which may be programmed into the memory device 150 to generate data to which a parity bit is added. The data including the parity bit may be stored in the memory device 150. The ECC decoder may detect and correct an error contained in the data read from the memory device 150. In other words, when an error is detected, the ECC component 138 may perform an error correction decoding process onto the data read from the memory device 150 through an ECC code used during an ECC encoding process. According to a result of the error correction decoding process, the ECC component 138 may output a signal, for example, an error correction success/fail signal. When the number of error bits is more than a threshold value of correctable error bits, the ECC component 138 may not correct the error bits, and may output an error correction fail signal.

By way of example but not limitation, the ECC component 138 may perform error correction through a coded modulation such as a Low Density Parity Check (LDPC) code, a Bose-Chaudhri-Hocquenghem (BCH) code, a turbo code, a Reed-Solomon code, a convolution code, a Recursive Systematic Code (RSC), a Trellis-Coded Modulation (TCM) and a Block coded modulation (BCM). However, the ECC component 138 is not limited thereto. The ECC component 138 may include relevant circuits, modules, systems or devices for use in error correction.

The PMU 140 may provide and manage the electrical power requirements of the controller 130.

The memory interface 142 may work as a memory/storage interface for operatively coupling the controller 130 and the memory device 150 such that the controller 130 may control the memory device 150 in response to a request from the host 102. When the memory device 150 is a flash memory (e.g., a NAND flash memory), the memory interface 142 may be NAND flash controller (NFC). The memory interface 142 may generate a control signal for the memory device 150 to provide data into the memory device 150 under the control of the processor 134. The memory interface 142 may work as an interface (e.g., a NAND flash interface) for processing a command and data between the controller 130 and the memory device 150. Specifically, the memory interface 142 may support data transfer between the controller 130 and the memory device 150. The memory interface142 may include a firmware, that is, a flash interface layer (FIL) for exchanging data with the memory device 150.

The memory 144 may serve as a working memory of the memory system 110 and the controller 130. The memory 144 may store data for driving the memory system 110 and the controller 130. The controller 130 may control the memory device 150 to perform read, program, and erase operations in response to a request from the host 102. The controller 130 may output data, read from the memory device 150, to the host 102. The controller 130 may store data, entered from the host 102, into the memory device 150. The memory 144 may store data required for the controller 130 and the memory device 150 to perform these operations.

The memory 144 may be a volatile memory. By way of example but not limitation, the memory 144 may be a static random-access memory (SRAM) or dynamic random-access memory (DRAM). The memory 144 may be disposed within or external to the controller 130. FIG. 1 exemplifies the memory 144 disposed within the controller 130. In an embodiment, the memory 144 may be an external volatile memory having a memory interface transferring data between the memory 144 and the controller 130.

As described above, the memory 144 may include a program memory, a data memory, a write buffer/cache, a read buffer/cache, a data buffer/cache and a map buffer/cache for storing either some data, required to perform data write and read operations by the host 102 at the memory device 150, or other data, required for the controller 130 and the memory device 150, to perform these operations.

The processor 134 may control the overall operations of the memory system 110. The processor 134 may use a firmware to control the overall operations of the memory system 110. The firmware may be referred to as flash translation layer (FTL).

By way of example but not limitation, the controller 130 may perform an operation requested by the host 102 in the memory device 150 through the processor 134, which may be implemented as a microprocessor, a CPU, or the like. In other words, the controller 130 may perform a command operation corresponding to a command received from the host 102. Herein, the controller 130 may perform a foreground operation as the command operation corresponding to the command received from the host 102. Examples of the foreground operation may include a program operation corresponding to a write command, a read operation corresponding to a read command, an erase operation corresponding to an erase command, and a parameter set operation corresponding to a set parameter command, or a set feature command as a set command.

Also, the controller 130 may perform a background operation on the memory device 150 through the processor 134, which may be realized as a microprocessor or a CPU. Examples of the background operation performed on the memory device 150 may include an operation of copying and processing data stored in some memory blocks among the memory blocks 152 to 156 of the memory device 150 into other memory blocks, e.g., a garbage collection (GC) operation. Examples of the background operation may include an operation of performing swapping between the memory blocks 152 to 156 of the memory device 150 or between the data of the memory blocks 152 to 156, e.g., a wear-leveling (WL) operation. Examples of the background operation may include an operation of storing the map data stored in the controller 130 in the memory blocks 152 to 156 of the memory device 150, e.g., a map flush operation. Examples of the background operation may include an operation of managing bad blocks of the memory device 150, e.g., a bad block management operation of detecting and processing bad blocks among the memory blocks 152 to 156 included in the memory device 150.

Further, the controller 130 may perform a plurality of command executions corresponding to a plurality of commands received from the host 102, e.g., a plurality of program operations corresponding to a plurality of write commands, a plurality of read operations corresponding to a plurality of read commands, and a plurality of erase operations corresponding to a plurality of erase commands, in the memory device 150. Also, the controller 130 may update a meta-data, (particularly, a map data) sporadically or periodically, according to the plurality of command executions.

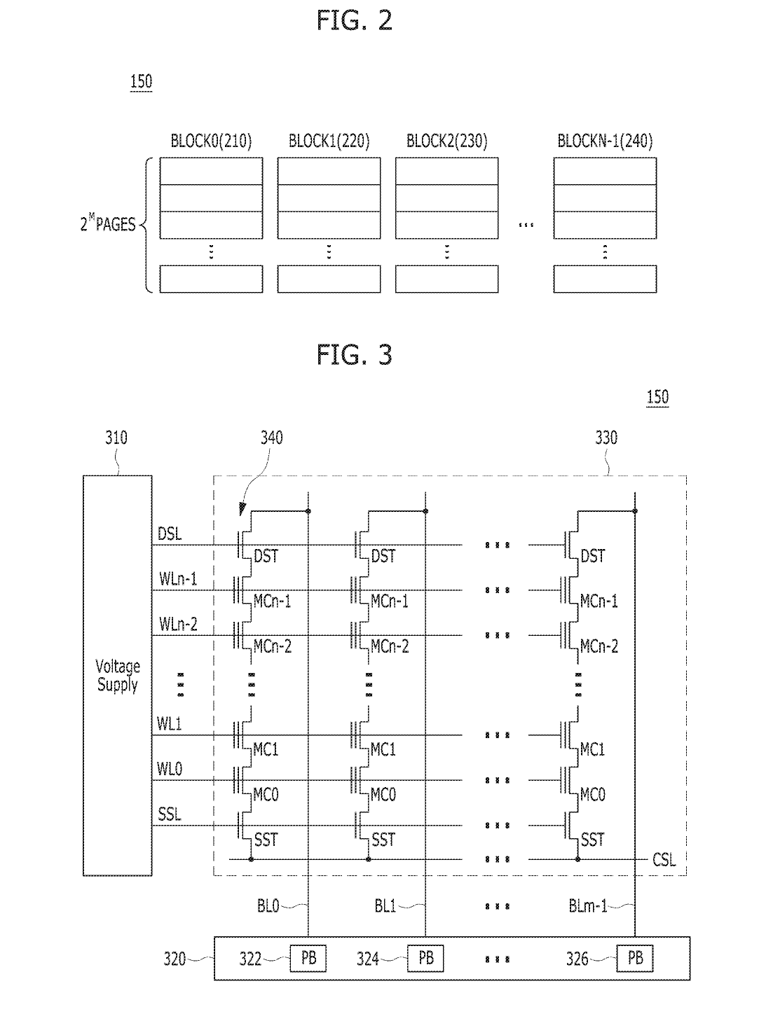

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation performing with more reliability is needed. Hereafter, the memory device of the memory system, in accordance with the described embodiment of the invention is described in detail with reference to FIGS. 2 to 3.

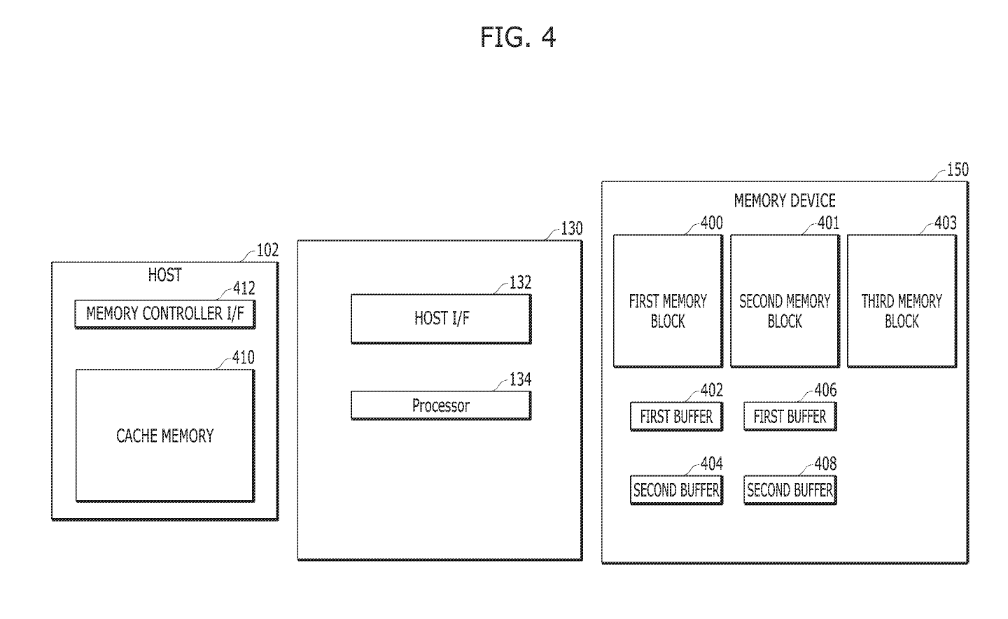

FIG. 2 is a simplified schematic diagram illustrating the memory device 150, FIG.3 is a circuit diagram illustrating an exemplary configuration of a memory cell array of a memory block 330 in the memory device 150 and FIG. 4 is a simplified schematic diagram illustrating an exemplary 3D structure of the memory device 150.

Referring to FIG. 2, the memory device 150 may include a plurality of memory blocks BLOCKO 210 to BLOCKN-1 240. Each of the blocks BLOCKO 210 to BLOCKN-1 240 may include a plurality of pages, for example, 2^{M} pages, the number of which may vary according to circuit design. Herein, although it is described that each of the memory blocks include 2^{M} pages, each of the memory blocks 210 to 240 may include M pages as well. Each of the pages may include a plurality of memory cells that are coupled to a plurality of word lines WL.

Also, memory cells included in the respective memory blocks BLOCKO 210 to BLOCKN-1 240 may be one or more of a single level cell (SLC) memory block storing 1-bit data and/or a multi-level cell (MLC) memory block storing 2-bit data. Hence, the memory device 150 may include SLC memory blocks or MLC memory blocks, depending on the number of bits which can be expressed or stored in each of the memory cells in the memory blocks. The SLC memory blocks may include a plurality of pages which are embodied by memory cells each storing one-bit data. The SLC memory blocks may generally have higher data computing performance and higher durability than the MCL memory blocks. The MLC memory blocks may include a plurality of pages which are embodied by memory cells each storing multi-bit data (for example, 2 or more bits). An MLC memory block may generally have a larger data storage space than an SLC memory block of the same size, that is, an MLC may have a higher integration density. In another embodiment, the memory device 150 may include a plurality of triple level cell (TLC) memory blocks. In yet another embodiment, the memory device 150 may include a plurality of quadruple level cell (QLC) memory blocks. The TCL memory blocks may include a plurality of pages which are embodied by memory cells, each capable of storing 3-bit data. The QLC memory blocks may include a plurality of pages which are embodied by memory cells, each capable of storing 4-bit data.

Although the embodiment of the invention exemplarily describes, for convenience, that the memory device 150 may be a flash memory such as a NAND flash memory, it may also be implemented by various other memory devices such as a phase change random-access memory (PCRAM), a resistive random-access memory (RRAM(ReRAM)), a ferroelectric random-access memory (FRAM), and a spin transfer torque magnetic random-access memory (STT-RAM(STT-MRAM)).

The memory blocks 210, 220, 230, 240 may store the data transferred from the host 102 through a program operation, and transfer data stored therein to the host 102 through a read operation.

Referring to FIG. 3, the memory block 330 may include a plurality of cell strings 340 coupled to a plurality of corresponding bit lines BL0 to BLm-1. The cell string 340 of each column may include one or more drain select transistors DST and one or more source select transistors SST. Between the source and drain select transistors SST and DST, a plurality of memory cells MC0 to MCn-1 may be coupled in series. In an embodiment, each of the memory cell transistors MC0 to MCn-1 may be embodied by an MLC capable of storing data of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1.

Although FIG. 3 illustrates NAND flash memory cells, the present disclosure is not limited thereto. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages, including a program voltage, a read voltage, and a pass voltage, to supply to the word lines according to an operation mode. The program voltage, the read voltage and the pass voltage may have different voltage levels for their functions. A control circuit (not illustrated) may control the voltage generation operation of the voltage supply 310. Under the control of the control circuit, the voltage supply 310 may select one of the memory blocks (or sectors) of the memory cell array and select one of the word lines of the selected memory block. The voltage supply 310 may provide different word line voltages to the selected word line and the unselected word lines as may be needed.

The memory device 150 may include a read and write (read/write) circuit 320 which is controlled by the control circuit. During a verification/normal read operation, the read/write circuit 320 may operate as a sense amplifier for reading data from a certain memory cell array of the memory block 330. During a program operation, the read/write circuit 320 may operate as a write driver for controlling a level of current flowing through bit lines according to data to be stored in the memory cell array. During a program operation, the read/write circuit 320 may receive from a buffer (not illustrated) data to be stored into the memory cell array. The read/write circuit 320 may control a level of current flowing through bit lines according to the received data. The read/write circuit 320 may include a plurality of page buffers 322 to 326 respectively corresponding to columns (or bit lines) or column pairs (or bit line pairs). Each of the page buffers (PBs) 322 to 326 may include a plurality of latches (not illustrated).

The flash memory has characteristics of programming and reading data on a per-page basis and of removing data on a per-block basis. Further, the flash memory does not have a characteristic of supporting an overwrite operation in a specific cell without an erasing operation, which is different when compared to a characteristic of a hard disk. Therefore, to amend or correct data recorded in original pages, amended or corrected data is recorded in new pages, not the original pages, and the original pages are invalidated.

A garbage collection operation refers to an operation of sporadically or periodically converting invalidated pages into blank pages, e.g., programmable pages, to avoid a flash memory space from being wasted due to the invalidated pages. The garbage collection operation includes a series of processes of selecting a victim block from all memory blocks included in a memory device and copying valid pages of the victim block to blank pages of a target block. After all the valid pages of the selected victim block are copied to the blank pages of the target block, all pages of the victim block become blank pages (i.e., the victim block is erased) so that the flash memory space may be recovered through the garbage collection operation.

To perform the garbage collection operation, a memory for transmitting valid data is required. In a conventional memory system, since a capacity of the memory is limited, valid data of all victim blocks included in a memory system may not be transmitted to the memory at once. Therefore, operations of reading the valid data of the victim blocks up to the limited capacity of the memory, buffering the valid data in a first buffer, and transmitting the valid data of the first buffer to the memory have to be repeatedly performed. When the memory is full of the valid data, the valid data are programmed into the target block. The valid data of all the victim blocks may be programmed into the target block by repetition of such a series of read, buffering, and program operations.

As described above, in a conventional memory system, the valid data buffered in the first buffer is directly transmitted to the memory without being buffered in a second buffer. Therefore, only when all the valid data buffered in the first buffer are transmitted to the memory, other valid data may be read from a memory block. While the valid data buffered in the first buffer are transmitted to the memory, a pre-read operation of reading other valid data of the victim block may not be performed, which reduces the speed and performance of the garbage collection operation.

In addition, in a conventional memory system, the valid data of all the victim blocks included in the memory device may not be transmitted to the memory at once due to the limited capacity of the memory. When the capacity of the memory is full, the valid data of the memory is programmed into the target block. When the program operation is completed, remaining valid data of the victim block is read. Therefore, the read operation and the program operation are repeatedly performed until all the valid data of the victim block is programmed into the target block.

Some valid data of the victim block is transmitted to the memory, and other valid data of the victim block may not be read while the valid data of the memory is programmed into the target block. That is, to read the valid data remaining in the victim block, a delay time to be waited until all the valid data of the memory are programmed into the victim block occurs.

According to an embodiment of the invention, the problem of not being able to perform the pre-read operation and the problem of delay time occurring may be prevented, increasing the speed and performance of the garbage collection operation.

FIG. 4 is a simplified block diagram illustrating an exemplary configuration of the memory device 150 and the controller 130 employed in the data processing system 100 shown in FIG. 1.

Referring to FIG. 4, the host 102 may include a memory controller interface (I/F) 412 and a cache memory 410.

As described above with reference to FIG. 1, the processor 134 may control an overall operation of the memory system 110. For example, the processor 134 may control program and read operations performed in a background operation for the memory device 150.

The memory controller I/F 412 and the host interface (I/F) 132 may transmit data between the memory system 110 and the host 102.

The cache memory 410 is a unified memory (UM). The UM may store data in a region of the host 102 in response to a request of the memory system 110.

The memory system 110 may include a channel capable of communicating between the host 102 and the memory system 110 for storing data in the cache memory 410 or for reading data of the cache memory 410.

The memory device 150 may include a plurality of memory blocks, for example, memory blocks 400, 401, 403, a plurality of first buffers, for example, first buffers 402 and 406, and a plurality of second buffers, for example, second buffers 404 and 408. Although not illustrated, the memory blocks 400, 401, 403 may be included in a memory cell array in the memory device.

Data read from the memory block 400 may be buffered in the first buffer 402, and data buffered in the first buffer 402 may be buffered in the second buffer 404. This operation in which the first and second buffers temporarily store data transmitted by the controller 130 may also be referred as a ‘buffering operation.’

The controller 130 may detect a memory block among the memory blocks 400, 401, 403 having a valid page count equal to or lower than a threshold value as a garbage collection target block. Hereinafter, a garbage collection target block may also be referred to as a ‘victim block 400.’ The detected victim block 400 is illustrated as a single memory block for convenience in description. It is noted, however, that the victim block 400 may include one or more memory blocks detected as garbage collection target blocks from the plurality of memory blocks included in the memory device 150.

When the number of the detected victim blocks is equal to or higher than a threshold value, then the controller 130 may read the valid data from the victim block 400, and buffer the read valid data in the first buffer 402.

The controller 130 may buffer the valid data buffered in the first buffer 402 in the second buffer 404. That is, the controller 130 may transmit the valid data stored temporarily in the first buffer 402 to the second buffer 404, and temporarily store the transmitted valid data in the second buffer 404. The controller 130 may remove the valid data buffered from the first buffer 402 to the second buffer 404 from the first buffer 402.

The controller 130 may cache the valid data buffered in the second buffer 404 in the cache memory 410 of the host 102. While the valid data of the second buffer 404 are cached in the cache memory 410, the controller 130 may read other valid data from the victim block 400 and buffer the read valid data in the first buffer 402.

The controller 130 may perform an operation of buffering the valid data in the first buffer 402 and the second buffers 404 and an operation of caching the valid data in the cache memory 410 in a pipelining scheme.

The pipelining scheme allows performing a plurality of operations at the same time to rapidly perform an operation which would otherwise would require longer time to be performed.

An operation of caching the valid data of the second buffer 404 in the cache memory 410 and an operation of reading other valid data from the victim block 400 can be performed at the same time according to the pipelining scheme applied to the present invention. Thus, the valid data of all the victim blocks may be rapidly cached in the cache memory 410 as compared with the conventional memory system and method described below.

Accordingly, in the conventional memory system, the data buffered in the first buffer is directly transmitted to the memory of the controller 130 without buffering the data in the second buffer. Therefore, to read other valid data from the victim block, it is necessary to wait until the valid data of the first buffer is transmitted to the memory of the controller 130. That is, while the valid data of the first buffer is transmitted to the memory, other valid data cannot be read from the victim block in advance, according to a conventional memory system and method.

In contrast, according to the embodiment of the present invention, the second buffer 404 may buffer the valid data buffered in the first buffer 402. The controller 130 may then read other valid data of the victim block 400 in advance while caching the valid data of the second buffer 404 in the cache memory 410. That is, by introducing the second buffer 404, all the valid data of the memory block may be rapidly transmitted to the cache memory 410 according to the described pipelining scheme.

Specifically, although a time required for buffering the valid data of the first buffer 402 in the second buffer 404 (hereinafter referred to as a cache buffering time) is longer than one in a conventional memory system, the cache buffering time may be shorter than a time required until all the valid data of the first buffer are transmitted to the memory of the controller (hereafter, referred to as a “valid data transmission time”) in the conventional memory system.

As a result, in accordance with the described embodiment of the invention, the valid data of the victim block 400 may be cached in the cache memory 410 more rapidly according to a difference between the valid data transmission time and the cache buffering time.

The controller 130 may delete the valid data cached in the cache memory 410 from the second buffer 404, and buffer other valid data buffered in the first buffer 402 in the second buffer 404.

When all the valid data of the victim block are cached in the cache memory 410 through a series of buffering and caching operations, the controller 130 may perform the program operation of storing the valid data of the cache memory 410 in detected target blocks. The controller 130 may detect blocks whose free page count is equal to or higher than the threshold value from the plurality of memory blocks as the target blocks.

In accordance with the embodiment of the invention, the controller 130 may read the valid data of all the victim blocks in the cache memory 410 at one time using the cache memory 410 of the host 102. The controller 130 may program the read valid data into the target blocks at one time in an interleaving scheme. That is, different from the prior art, since a memory space is sufficient, an operation of reading the valid data from the victim blocks and an operation of programming the valid data into the target blocks may not be overlapped.

Accordingly, the garbage collection operation may be performed more rapidly. Specifically, the garbage collection operation may be performed as more rapidly as the delay time which is the time to be waited until all the valid data of the memory are programmed into the victim blocks to read the valid data remaining in the victim blocks.

When all the valid data of the cache memory 410 are programmed into the target blocks, the controller 130 may secure the memory space by removing all the data of the victim blocks.

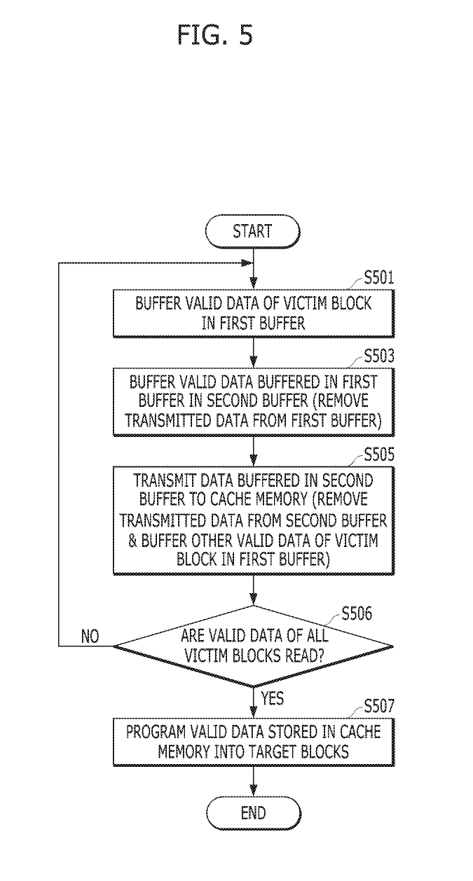

FIG. 5 is a flowchart illustrating the garbage collection operation, in accordance with the embodiment of the invention.

The garbage collection operation according to the present invention may include buffering valid data of the victim block 400 included in the memory device in the first buffer 402 in step S501, buffering the valid data buffered in the first buffer 402 in the second buffer 404 in step S503 and removing the transmitted data from the first buffer 402. The garbage collection operation may further include caching the valid data which are buffered in the second buffer 404 in the cache memory 410 of the host 102 (hereinafter referred to as a “caching operation”). During the caching operation in step S505, buffering of other valid data of the victim block 400 in the first buffer 402 may be performed. After the caching operation in step S505, it may be determined whether the valid data of all victim blocks are read in step S506. When the caching operation is performed on valid data read from all victim blocks (that is, “YES” at step S506), programming of the valid data which are cached in the cache memory 410 into target blocks included in the memory device is performed in step S507. When the caching operation has not been performed on valid data read from all victim blocks (that is, “NO” at step S506), the garbage collection operation returns to step 501 and repeats steps 501 to 506 until the valid data of all victim blocks are read.

Before the step S501 is carried out, a memory block having a valid page count equal to or lower than a threshold value among the plurality of memory blocks 400, 401, 403 may be detected as the victim block 400. As described earlier, although the detected victim block 400 is illustrated as a single memory block for convenience in description, the victim block 400 may be one or more memory blocks detected as the garbage collection target blocks from the plurality of memory blocks included in the memory device 150. When the number of the detected victim blocks is equal to or higher than a threshold value, valid data may be read from the victim block 400, and subsequently the step S501 may be carried out.

An operation of buffering the valid data read from the victim block 400 in the first buffer 402 and an operation of buffering valid data read from another victim block 401 in the first buffer 406 may be performed at the same time.

In step S503, the valid data of the first buffer 402 may be buffered in the second buffer 404, and the valid data buffered in the second buffer 404 may be removed from the first buffer 402.

In step S505, while the valid data of the second buffer 404 are cached in the cache memory 410 included in the host 102, other valid data may be read from the victim block 400 and buffered in the first buffer 402.

In step S507, when the valid data of all the victim blocks are cached in the cache memory 410 through a series of the buffering and caching operations, the valid data of the cache memory 410 may be programmed into detected target blocks. Each of the target blocks is a block whose free page count is equal to or higher than a threshold value among the plurality of memory blocks.

In step S507, the valid data read from the victim block 400 may be programmed into the target blocks at one time in an interleaving scheme. In other words, since a memory space is sufficient, an operation of reading the valid data from the victim block and an operation of programming the valid data into the target blocks may not be overlapped.

In step S507, when all the valid data of the cache memory 410 are programmed into the target blocks, all the data of the victim blocks may be removed.

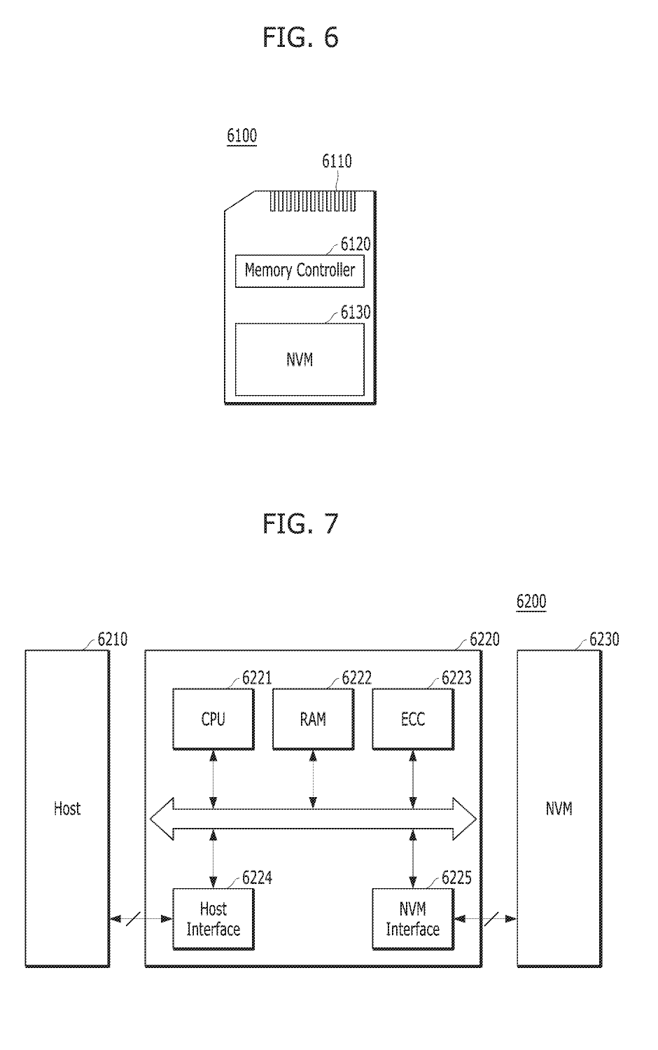

Hereafter, various data processing systems and electronic devices to which the memory system 110 including the memory device 150 and the controller 130, as described above with reference to FIGS. 1 to 5, in accordance with the embodiment of the disclosure will be described in detail with reference to FIGS. 6 to 14.

FIG. 6 is a diagram schematically illustrating an example of the data processing system including the memory system, in accordance with the embodiment. FIG. 6 schematically illustrates a memory card system to which the memory system, in accordance with the embodiment is applied.

Referring to FIG. 6, the memory card system 6100 may include a memory controller 6120, a memory device 6130 and a connector 6110.

More specifically, the memory controller 6120, configured to access the memory device 6130, may be electrically connected to the memory device 6130 embodied by a nonvolatile memory. For example, the memory controller 6120 may be configured to control read, write, erase and background operations of the memory device 6130. The memory controller 6120 may be configured to provide an interface between the memory device 6130 and a host, and to use a firmware for controlling the memory device 6130. That is, the memory controller 6120 may correspond to the controller 130 of the memory system 110 described with reference to FIGS. 1, while the memory device 6130 may correspond to the memory device 150 of the memory system 110 described with reference to FIGS. 1.

Thus, the memory controller 6120 may include a RAM, a processing unit, a host interface, a memory interface and an error correction unit.

The memory controller 6120 may communicate with an external device, for example, the host 102 of FIG. 1 through the connector 6110. By the way of example but not limitation, as described with reference to FIG. 1, the memory controller 6120 may be configured to communicate with an external device under one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system, in accordance with the present embodiment may be applied to wired/wireless electronic devices or specific mobile electronic devices.

The memory device 6130 may be implemented by a nonvolatile memory. By the way of example but not limitation, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may construct a solid-state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., a SM and a SMC), a memory stick, a multimedia card (e.g., an MMC, a RS-MMC, a MMCmicro and an eMMC), an SD card (e.g., a SD, a miniSD, a microSD and a SDHC) and a universal flash storage (UFS).

FIG. 7 is a diagram schematically illustrating an example of the data processing system including the memory system, in accordance with the present embodiment.

Referring to FIG. 7, the data processing system 6200 may include a memory device 6230 having one or more nonvolatile memories and a memory controller 6220 for controlling the memory device 6230. The data processing system 6200 illustrated in FIG. 7 may serve as a storage medium such as a memory card (a CF, a SD, a micro-SD or the like) or USB device, as described with reference to FIGS. 1. The memory device 6230 may correspond to the memory device 150 in the memory system 110 illustrated in FIGS. 1. The memory controller 6220 may correspond to the controller 130 in the memory system 110 illustrated in FIG. 1.

The memory controller 6220 may control a read, write or erase operation on the memory device 6230 in response to a request of the host 6210. The memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 nr ay be used for buffering data transmitted to the memory device 6230 from the host 6210 or vice versa. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may carry out a wireless communication function with a mobile communication protocol such as WiFi or Long-Term Evolution (LTE). The memory controller 6220 may be connected to an external device, for example, the host 6210 or another external device, and then transmit/receive data to/from the external device. As the memory controller 6220 is configured to communicate with the external device through one or more of various communication protocols, the memory system and the data processing system, in accordance with the present embodiment may be applied to wired/wireless electronic devices or particularly a mobile electronic device.

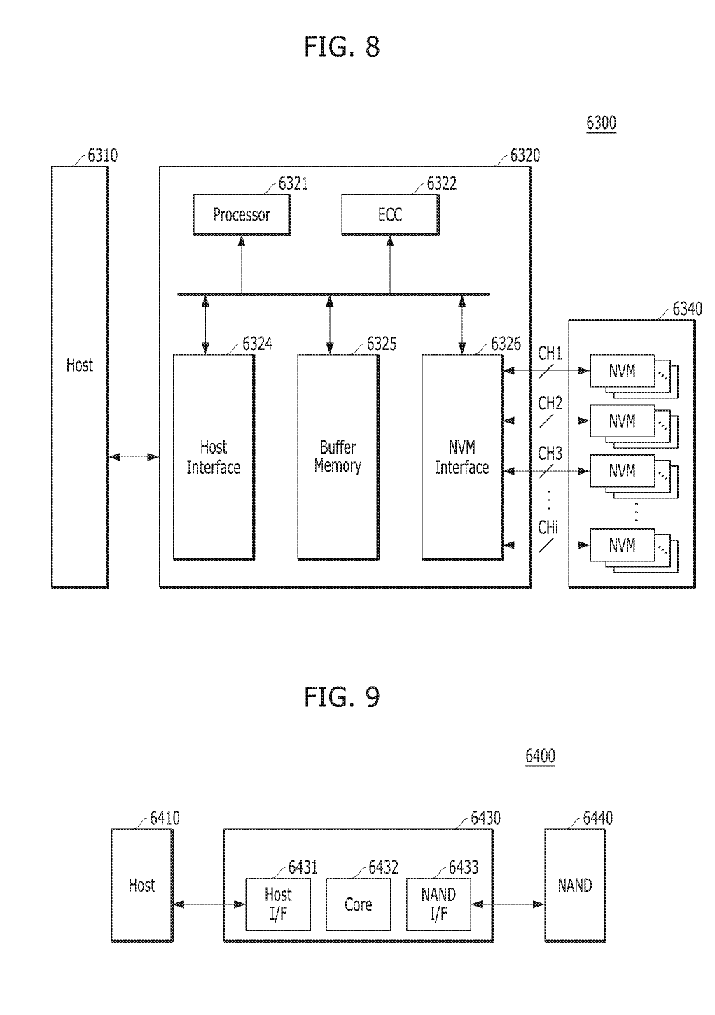

FIG. 8 is a diagram schematically illustrating an example of the data processing system including the memory system, in accordance with the present embodiment. FIG. 8 schematically illustrates an SSD to which the memory system, in accordance with the present embodiment is applied.

Referring to FIG. 8, the SSD 6300 may include a controller 6320 and a memory device 6340 including a plurality of nonvolatile memories. The controller 6320 may correspond to the controller 130 in the memory system 110 of FIGS. 1, and the memory device 6340 may correspond to the memory device 150 in the memory system of FIGS. 1.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340. Further, the buffer memory 6325 may temporarily store meta data of the plurality of flash memories NVM, for example, map data including a mapping table. The buffer memory 6325 may be embodied by volatile memories such as a DRAM, a SDRAM, a DDR SDRAM, a LPDDR SDRAM and a GRAM or nonvolatile memories such as a FRAM, a ReRAM, a STT-MRAM and a PRAM. For convenience of description, FIG. 8 illustrates that the buffer memory 6325 exists in the controller 6320. However, the buffer memory 6325 may locate outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIGS. 1 is applied may be provided to embody a data processing system, for example, RAID (Redundant Array of Independent Disks) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, to output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, to output data read from the selected SSDs 6300 to the host 6310.

FIG. 9 is a diagram schematically illustrating an example of the data processing system including the memory system, in accordance with the present embodiment. FIG. 9 schematically illustrates an embedded Multi-Media Card (eMMC) to which the memory system, in accordance with the present embodiment is applied.

Referring to FIG. 9, the eMMC 6400 may include a controller 6430 and a memory device 6440 embodied by one or more NAND flash memories. The controller 6430 may correspond to the controller 130 in the memory system 110 of FIGS. 1. The memory device 6440 may correspond to the memory device 150 in the memory system 110 of FIGS. 1.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410. The NAND interface 6433 may provide an interface function between the memory device 6440 and the controller 6430. By the way of example but not limitation, the host interface 6431 may serve as a parallel interface such as an MMC interface as described with reference to FIG. 1. Furthermore, the host interface 6431 may serve as a serial interface, for example, UHS ((Ultra High Speed)-I/UHS-II) interface.

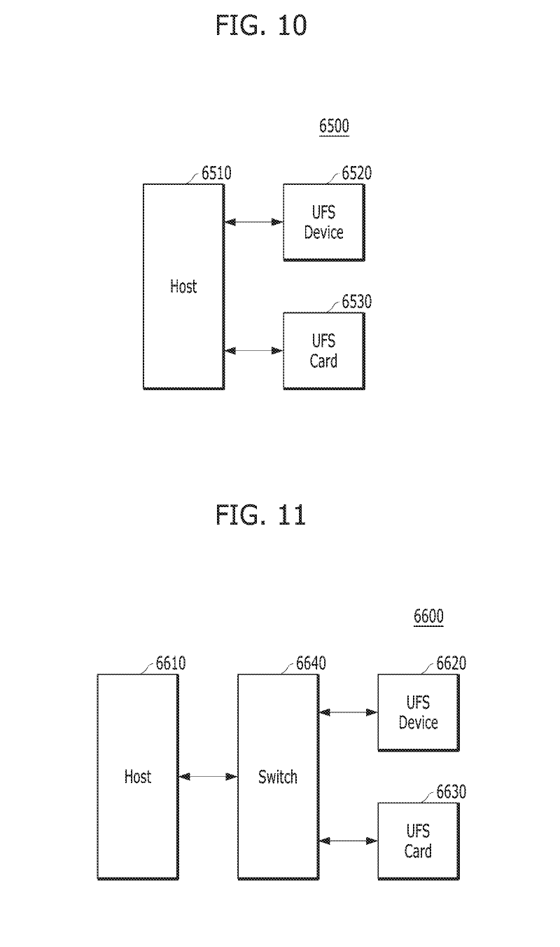

FIGS. 10 to 13 are diagrams schematically illustrating various examples of the data processing system including the memory system, in accordance with the present embodiment. FIGS. 10 to 13 schematically illustrate UFS (Universal Flash Storage) systems to which the memory system, in accordance with the present embodiment is applied.

Referring to FIGS. 10 to 13, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in

FIGS. 1. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 7 to 9, and the UFS cards 6530, 6630, 6730, 6830 may be embodied in the form of the memory card system 6100 described with reference to FIG. 6.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, for example, an UFDs, an MMC, a SD, a mini-SD, and a micro-SD.

In the UFS system 6500 illustrated in FIG. 10, each of the host 6510, the UFS device 6520 and the UFS card 6530 may include UniPro. The host 6510 may perform a switching operation to communicate with the UFS device 6520 and the UFS card 6530. Particularly, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410. Here, the form of a star is a sort of arrangement where a single device is coupled with plural devices for centralized operation. A plurality of UFS cards may be connected in parallel or in the form of a star to the UFS device 6520 or connected in series or in the form of a chain to the UFS device 6520.

In the UFS system 6600 illustrated in FIG. 11, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640. A plurality of UFS cards may be connected in series or in the form of a chain to the UFS device 6620.

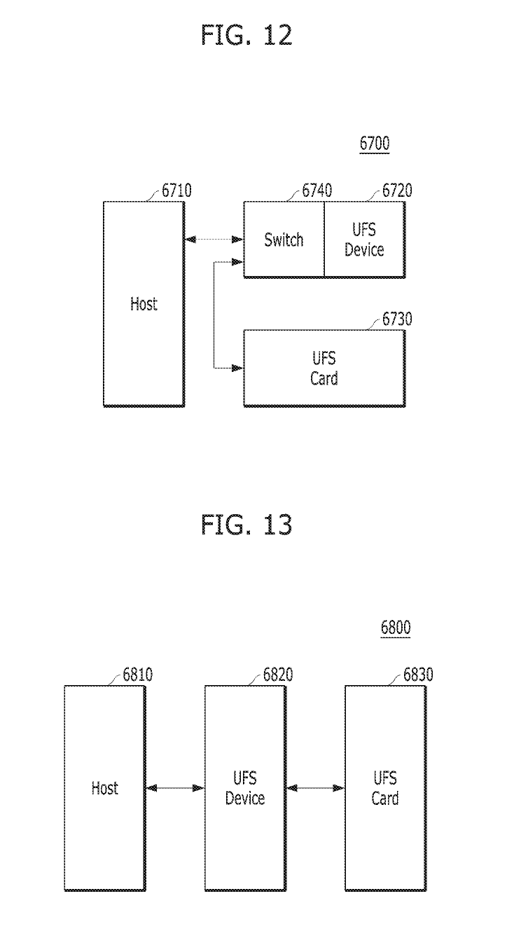

In the UFS system 6700 illustrated in FIG. 12, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro. The switching module 6740 may be integrated as one module with the UFS device 6720 inside or outside the UFS device 6720. In the embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 13, each of the host 6810, the UFS device 6820 and the UFS card 6830 may include M-PHY and UniPro. The UFS device 6820 may perform a switching operation to communicate with the host 6810 and the UFS card 6830. Paricularly, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. The host 6810 and the UFS card 6830 may communicate with each other through target ID switching between the M-PHY and UniPro modules of the UFS device 6820. In the embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810. A plurality of UFS cards may be connected in parallel or in the form of a star to the UFS device 6820, or connected in series or in the form of a chain to the UFS device 6820.

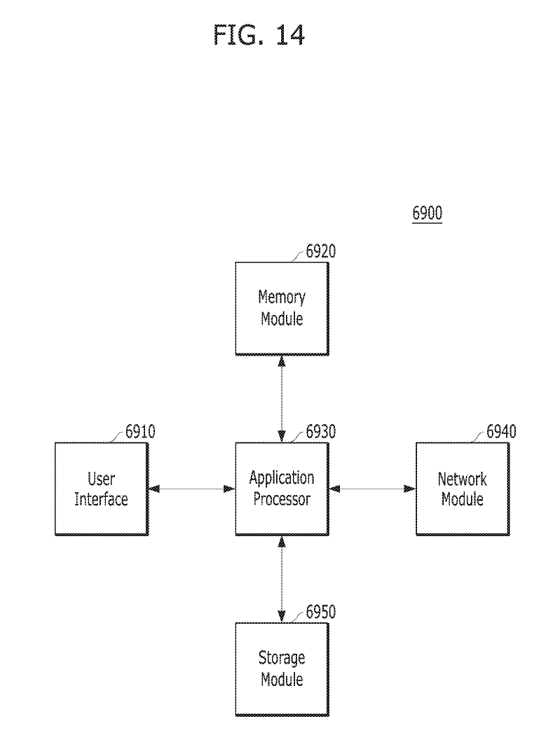

FIG. 14 is a diagram schematically illustrating an example of the data processing system including the memory system, in accordance with an embodiment of the invention. FIG. 14 is a diagram schematically illustrating a user system to which the memory system, in accordance with the embodiment is applied.

Referring to FIG. 14, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as a DRAM, a SDRAM, a DDR SDRAM, a DDR2 SDRAM, a DDR3 SDRAM, a LPDDR SDARM, a LPDDR3 SDRAM or a LPDDR3 SDRAM or a nonvolatile RAM such as a PRAM, a ReRAM, a MRAM or a FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or external drive of the user system 6900. The storage module 6950 may correspond to the memory system 110 described with reference to FIGS. 1. Furthermore, the storage module 6950 may be embodied as an SSD, an eMMC and an UFS as described above with reference to FIGS. 8 to 13.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device. The user interface 6910 may support a function of receiving data from the touch panel.

The memory system and the operating method thereof according to the embodiments may minimize complexity and performance deterioration of the memory system and maximize use efficiency of a memory, thereby quickly and stably process date with respect to the memory device.

Although various embodiments have been described for illustrative purposes, it will be apparent to those skilled in the art that various changes and modifications may be made without departing from the spirit and scope of the invention as defined in the following claims.

In accordance with embodiments of the embodiments, as a memory of a host region is used, a delay time caused by overlapping of a read operation and a program operation due to a limited capacity of a conventional memory may be prevented.

Also, in accordance with embodiments of the present embodiments, as a memory of a host region is used, valid data required for programming in a full interleaving scheme may be rapidly cache-read to the memory of the host region by using a secured memory space.

While the invention has been described with respect to specific embodiments, it will be apparent to those skilled in the art that various changes and modifications may be made without departing from the spirit and scope of the invention as defined in the following claims.

What is claimed is:

1. A data processing system, comprising:
a memory device;
a host including a cache memory;
first and second buffers; and
a controller suitable for controlling the memory device, the host, and the first and second buffers to perform a first buffering operation of buffering valid data of a victim block included in the memory device in the first buffer, a second buffering operation of buffering the valid data buffered in the first buffer in the second buffer, a caching operation of caching the valid data buffered in the second buffer in the cache memory, and a program operation of storing all the valid data of the victim block cached in the cache memory in target blocks included in the memory device,
wherein the controller performs the first and second buffering operations and the caching operation on the valid data of the victim block in a pipelining scheme between the host and the first and second buffers.

2. The data processing system of claim 1, wherein the controller removes the data buffered in the second buffer from the first buffer.

3. The data processing systemof claim 1, wherein the controller removes the data cached in the cache memory from the second buffer.

4. The data processing system of claim 1, wherein the controller detects a memory block having a valid page count equal to or lower than a threshold value as the victim block.

5. The data processing system of claim 4, wherein when a number of the detected victim blocks is equal to or higher than a threshold value, the controller buffers valid data of the victim blocks in the first buffer.

6. The data processing system of claim 5, wherein the controller buffers the valid data of a plurality of victim blocks in corresponding first buffers.

7. The data processing system of claim 1, wherein the cache memory is a unified memory (UM).

8. The data processing system of claim 1, wherein the controller stores or reads data in or to the cache memory through a channel between a host interface and a memory controller interface.

9. The data processing systemof claim 1, wherein the controller programs the valid data cached in the cache memory i o the target blocks in an interleaving scheme.

10. The data processing system of claim 1, wherein the controller removes all the data of the victim block when the valid data cached in the cache memory are programmed into the target blocks.

11. An operating method of a data processing system, comprising:
buffering valid data of a victim block included in a memory device in a first buffer;
buffering the valid data buffered in the first buffer in a second buffer;
caching the valid data buffered in the second buffer in a cache memory; and
programming all the valid data of the victim block cached in the cache memory into target blocks included in the memory device,
wherein the buffering of the valid data of the victim block in the first buffer, the buffering of the valid data of the first buffer in the second buffer, and the caching of the valid data of the second buffer in the cache memory are carried out in a pipelining scheme for the valid data of the victim block.

12. The operating method of claim 11, further comprising:
removing the data buffered in the second buffer from the first buffer.

13. The operating method of claim 11, further comprising:
removing the data cached in the cache memory from the second buffer.

14. The operating method of claim 11, wherein the victim block is a memory block having a valid page count equal to or lower than a threshold value.

15. The operating method of claim 14, wherein when a number of the victim blocks is equal to or higher than a threshold value, valid data of the victim blocks are buffered in the first buffer.

16. The operating method of claim 15, wherein the valid data of the victim blocks are buffered in corresponding first buffers.

17. The operating method of claim 11, wherein the cache memory is a unified memory (UM).

18. The operating method of claim 11, wherein an operation of storing or reading data in or to the cache memory is performed through a channel between a host interface and a memory controller interface.

19. The operating method of claim 11, wherein the programming of the valid data cached in the cache memory into the target blocks is carried out in an interleaving scheme.

20. The operating method of claim 11, further comprising:
removing all the data of the victim block when the valid data cached in the cache memory are programmed into the target blocks.
